(19) United States
(12) Patent Application Publication
(10) Pub. No.: US 2006/0187130 A1
(43) Pub. Date: Aug. 24, 2006

(54) Television box with an embedded antenna

(76) Inventors: Shih-Pin Lo, Taipei (TW); Li-Hsiang Liao, Taipei (TW); Chin-Yi Wu, Taipei (TW); Chun-Kai Chan, Taipei (TW)

Correspondence Address: RABIN & Berdo, PC, 1101 14TH STREET, NW, SUITE 500, WASHINGTON, DC, 20005, US

(21) Appl. No.: 11/359,614

(22) Filed: Feb. 23, 2006

(30) Foreign Application Priority Data
Feb. 24, 2005 (TW) 94105678

(51) Int. Cl. H01Q 1/24

(52) U.S. Cl. 343/702

(57) ABSTRACT

A television box with an embedded antenna includes a first antenna device and a printed circuit board. The first antenna device is for receiving a wireless signal. The printed circuit board is connected to the first antenna device for outputting image data according to the wireless signal.

This application claims the benefit of Taiwan application Serial No. 94105678, filed Feb. 24, 2005, the subject matter of which is incorporated herein by reference.

### BACKGROUND OF THE INVENTION

1. Field of the Invention

The invention relates in general to a television box, and more particularly to a television box with an embedded antenna.

2. Description of the Related Art

Referring to FIG. 1, a schematic diagram of a conventional television box is shown. Conventionally, the television box 100 can only receive wireless signals through an external antenna 110 by electrically connecting a plug 111 of the external antenna 110 to an insertion hole 102 of the television box 100.

The television box 100 can receive analog signals or digital signals. For example, the digital signals are wireless signals of a digital television specification such as a digital video broadcasting television (DVB-T), an advanced television systems committee (ATSC), or an integrated services digital broadcasting (ISDB) specification. The DVB-T digital television specification is a kind of European specification and is adopted in European countries and Taiwan, the ATSC is an American specification and the ISDB is a Japanese specification.

However, the external antenna 110 is very inconvenient in usage due to difficulty in carriage and antenna direction control.

### SUMMARY OF THE INVENTION

It is therefore an object of the invention to provide a television box with an embedded antenna.

The invention achieves the above-identified object by providing a television box including a first antenna device and a printed circuit board. The first antenna device is for receiving a wireless signal. The printed circuit board is connected to the first antenna device for outputting image data according to the wireless signal.

The invention achieves the above-identified object by providing another television box including a first antenna device, a printed circuit board, and a cable. The first antenna device is for receiving a wireless signal. The printed circuit board is connected to the first antenna device for outputting image data according to the wireless signal. The cable is for connecting the television box with a computer. The first antenna device is disposed in the cable, the cable includes a signal transmission line, and the television box communicates with the computer through the signal transmission line. The cable is flexible to support the television box to hang beside the computer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional television box.

FIG. 2A is a schematic diagram of the inner structure of a television box according to a first embodiment of the invention.

FIG. 2B is a schematic structure diagram of the television box according to the first embodiment of the invention.

FIG. 3 is a schematic structure diagram of a television box connecting to a computer according to a second embodiment of the invention.

FIG. 4A is a schematic structure diagram of the cable in FIG. 3.

FIG. 4B is a schematic diagram of another structure of the cable in FIG. 23.

### DETAILED DESCRIPTION OF THE INVENTION

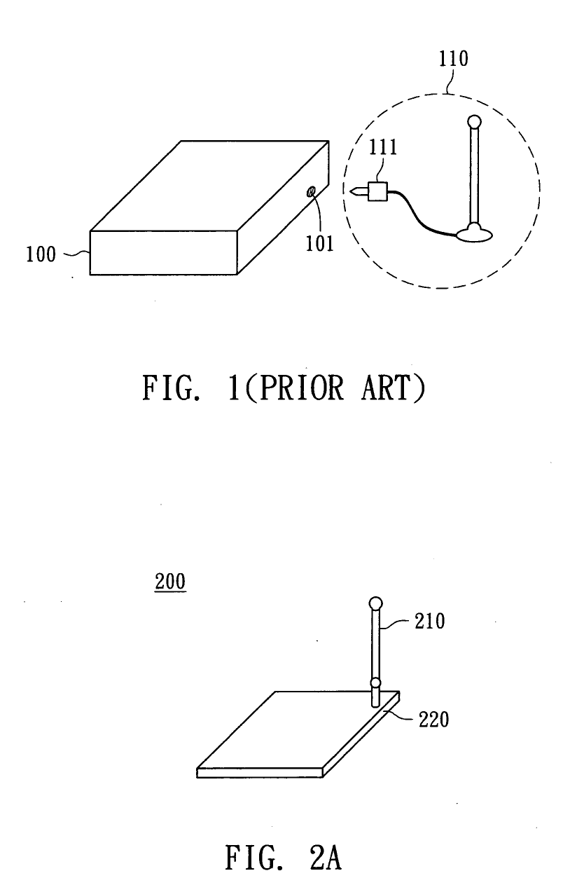

Referring to FIG. 2A, a schematic diagram of the inner structure of a television box according to a first embodiment of the invention is shown. The television 200 can be for example a universal serial bus (USB) television box. The television box 200 includes a first antenna device 210 and a printed circuit board 220, and the first antenna device 210 is welded on the printed circuit board 220. The first antenna device 210 can be a dipole antenna or a direction and length adjustable antenna device for instance.

The television box 200 can receive analog television signals or digital television signals. The television box 200 receiving digital television signals can receive wireless signals of a European DVBT, an American ATSC, or a Japanese ISDB digital television specification. The printed circuit board 220 outputs image data to display images on display devices such as a television set or a computer according to the above-mentioned wireless signals. A television box has generally an external antenna thereby increasing difficulty in carriage. The antenna of the embodiment is directly welded on the printed circuit board of the television box. Therefore, the television box can receive signals without an external antenna.

Referring to FIG. 2B, a schematic structure diagram of the television box according to the first embodiment of the invention is shown. The television box 200 further includes a housing 230, and the housing 230 includes an opening 231, a receiving trough 232 and an antenna extend terminal 233. The printed circuit board 220 is disposed in the housing 230 and the first antenna device 210 is extended from the interior to the exterior of the housing 230 through the opening 231.

The first antenna device 210 is length-adjustable and foldable. When the television box 200 is unused, the first antenna device 210 can be folded and placed in the receiving trough 232. When the television box 200 is to be used, the first antenna device 210 can be pulled out from the receiving trough 230 by its top-end and be adjusted to an optimal signal receiving status by changing its antenna direction and length.

When the signals received by the first antenna device 210 have a poor quality, the television box 200 can improve its signal receiving quality by connecting to a second antenna device through the antenna extend terminal 233. The second antenna device can be a dipole antenna, a monopole antenna, or a circular antenna, and can be chosen to have the most suitable antenna form as required. In the embodiment, the antenna is embedded in the television box and can be extended and received easily, thereby increasing convenience in carriage.

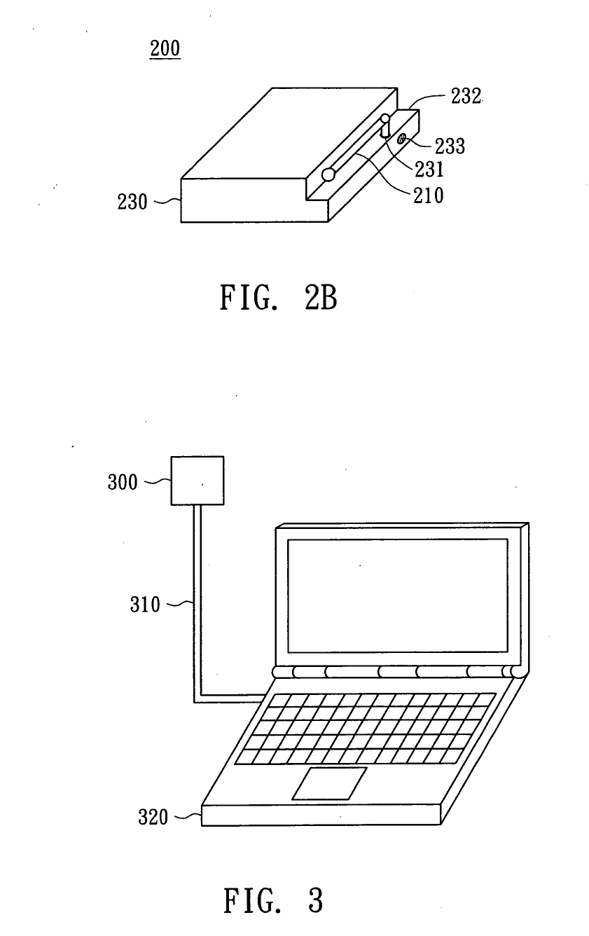

Referring to FIG. 3, a schematic structure diagram of a television box connecting to a computer according to a second embodiment of the invention is shown. The television box 300 has a cable 310 for electrically connecting to a computer 320. The cable 310 has function like an antenna and flexibly supports the television box 300 to hang beside the computer 320. Therefore, the television box 300 can get better signal receiving quality by changing the location of the cable 310. The cable 310 has also the function of signal transmission and can transmit image data outputted by the television box 300 to the computer 320 for display.

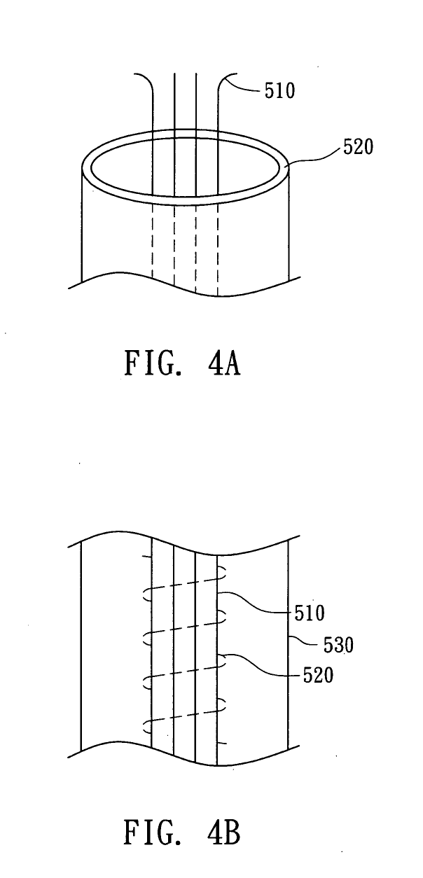

Referring to FIG. 4A, a schematic structure diagram of the cable 310 in FIG. 3 is shown. The cable 310 includes an outer covering of the cable 520 and a signal transmission line 510. The outer covering of the cable 520 is made of a flexible material and forms as a flexible outer covering of the cable 310 in order to support the television box 300 to hang beside the computer 320. Due to the feature of flexibility, the outer covering of the cable 520 can be adjusted to the optimal signal receiving status by altering its direction. The signal transmission line 510 is disposed in the outer covering of the cable 520 to communicate the television box 300 with the computer 320 while the outer covering of the cable 520 is connected to the antenna extend terminal of the television box 200.

Referring to FIG. 4B, a schematic diagram of another structure of cable is shown. The signal transmission line 510 is made of a flexible material to support the television box 300 to hang beside the computer 320. The outer covering of the cable 520 spirally wraps around the signal transmission line 510, and a layer of plastic outer covering then covers the outer covering of the cable 520. The signal transmission line 510 is also connected to the computer 320 and the printed circuit board 220.

As disclosed in the above-mentioned embodiment, the television box of the invention can improve its convenience in carriage by using an embedded antenna. On the other hand, due to direction adjustability of the antenna, the television box can have better signal receiving quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A television box, comprising:
a first antenna device, for receiving a wireless signal; and
a printed circuit board connected to the first antenna device for outputting image data according to the wireless signal.

2. The television box according to claim 1, wherein the first antenna device is a dipole antenna.

3. The television box according to claim 2, wherein the first antenna device is length-adjustable.

4. The television box according to claim 2, wherein the first antenna device is direction-adjustable.

5. The television box according to claim 1, further comprising a housing, wherein the housing has an opening, the printed circuit board is disposed in the housing, and the first antenna device is extended from the interior to the exterior of the housing via the opening.

6. The television box according to claim 5, wherein the housing includes a receiving trough at one side for receiving the first antenna device.

7. The television box according to claim 1, further comprising an antenna extend terminal.

8. The television box according to claim 7, wherein the antenna extend terminal is for connecting a second antenna device.

9. The television box according to claim 8, wherein the second antenna device is a dipole antenna.

10. The television box according to claim 1, wherein the television box is a universal serial bus (USB) television box.

11. The television box according to claim 10, wherein the USB television box is for receiving a wireless signal of a digital television specification.

12. The television box according to claim 1, wherein the digital television specification is a digital video broadcasting television (DVBT) specification.

13. The television box according to claim 1, wherein the digital television specification is an advanced television systems committee (ATSC) specification.

14. The television box according to claim 1, wherein the digital television specification is an integrated services digital broadcasting (ISDB) specification.

15. The television box according to claim 1, wherein the television box is electrically connected to a computer via a cable.

16. The television box according to claim 15, wherein the cable comprises a signal transmission line, and the television box communicates with the computer through the signal transmission line.

17. The television box according to claim 16, wherein the cable has a flexible outer covering to support the television box to hang beside the computer.

18. The television box according to claim 16, wherein the signal transmission line is flexible so as to support the television box to hang beside the computer.

19. A television box, comprising:
a first antenna device, for receiving a wireless signal;
a printed circuit board connected to the first antenna device for outputting image data according to the wireless signal; and
a cable, for connecting the television box with a computer;
wherein the first antenna device is disposed in the cable, the cable comprises a signal transmission line, and the television box communicates with the computer through the signal transmission line;
wherein the cable is flexible to support the television box to hang beside the computer.

20. The television box according to claim 19, wherein the cable has a flexible outer covering to support the television box to hang beside the computer.

21. The television box according to claim 19, wherein the first antenna device is flexible to support the television box to hang beside the computer.

22. The television box according to claim 19, wherein the signal transmission line is flexible to support the television to hang beside the computer.
